(19) United States
(12) Patent Application Publication
(10) Pub. No.: US 2005/0181763 A1
(43) Pub. Date: Aug. 18, 2005

(54) Method for duplicating and distributing information for identifying profiles of subcribers of a communication system

(76) Inventor: Janos-Gerold Enderlein, Berlin (DE)

Correspondence Address: BELL, BOYD & LLOYD, LLC, P. O. BOX 1135, CHICAGO, IL, 60690-1135, US

(21) Appl. No.: 10/511,870

(22) PCT Filed: Apr. 4, 2003
(86) PCT No.: PCT/DE03/01235

(30) Foreign Application Priority Data
Apr. 19, 2002 (DE) 102 18 808.4

(51) Int. Cl. H04M 3/16

(52) U.S. Cl. 455/411; 455/410

(57) ABSTRACT

A method and module are provided for duplicating and distributing information for identifying profiles of subscribers of a communication system, wherein: a) the subscribers define and store subscriber specific profiles via respective input units in a respective communication device and/or in a respective module coupled to a respective communication device; b) the profiles of other subscribers of the communication system are received a module coupled to one of the communication devices on the basis of wireless, locally defined network technology; c) the received profiles are compared to the defined and stored profile in the respective communication device according to a profile specific correlations threshold; d) the received profiles of the respective communication device are stored by activating the subscriber of the respective communication device and are compared to each respective profile specific correlation threshold; e) the received profiles of the respective communication device are stored by activating the subscriber of the respective communication device and are compared with profiles when a change in location of the respective communication device and/or the advancement of time according to the respective profile specific correlation thresholds, the profiles being newly-received and stored via a module coupled to the respective communication device on the basis of wireless, locally defined network technology as a result of a change in location and/or a lapse of time; and f) respective exceeding of the profile specific correlation thresholds is indicated to the respective subscribers of the corresponding subscriber specific profiles.

### BACKGROUND OF THE INVENTION

The present invention relates to a method for duplicating and distributing information for identifying profiles of subscribers of a communication system, particularly in a wireless communication system. When searching for particular supply and demand profiles, it is often desirable, firstly, to be able to make an anonymous selection from various selectable profiles before making direct contact with a subscriber having a particular profile, but secondly, also, to have the simultaneous option of immediately making personal contact with an appropriate subscriber. To date, it has been typical to draw up a supply or a demand oneself using conventional media, such as print (advertisement), internet (e.g., web page), or mobile radio technologies, such as by using questionnaires from suppliers. This supply is then compared manually, partially automatically or fully automatically with supplies and demands already stored. By way of example, the cognitive comparison of advertisements with the searching party's request profile, internet searching using search engines and the use of search robots may be mentioned in this context. Making direct immediate contact with a particular subscriber in combination with anonymous preselection has not been possible to date. As already mentioned, it is known practice to adjust supply and demand profiles through locally unlimited connection and correlation of the transmitted profiles; for example using search engines on the internet or in the cellular network. One drawback of this approach is the local “lack of limitation” for applications, such as partner searching or the formation of communities. This approach results in a multiplicity of correlations which are irrelevant because they are not available on an ad hoc basis.

In addition, it is known practice from DE 102 12 248 to be able to adjust supply and demand profiles through locally limited ad hoc connections and correlation of the transmitted profiles using wireless LAN (local area network)/PAN (personal area network) technology. A module for providing wireless, locally limited LAN/PAN network technology and for implementing the adjustment functionality is combined with a mobile telephone in this context. In the module, a first subscriber defines and stores a supply, demand or interest profile. The module uses the LAN/PAN standard Bluetooth, for example, to make contact automatically with each further module which is in the radio cell. When a further module has been identified, an ad hoc connection to this module is set up and the profiles of the corresponding subscribers are transmitted to the first subscriber. The profiles are then correlated. Following correlation, a correlation threshold defined beforehand by the subscriber decides whether both profiles are to be assessed as sufficiently matching. If this is the case, the subscriber is then informed in suitable fashion about a positive correlation result. The subsequent personal contact made with the subscribers is made by assigning temporarily valid telephone numbers. In the opposite case of insufficient match between the profiles, there is no possibility of making contact. A drawback of this approach is the severe local limiting of the ad hoc connection by the limited range of the network technology used; for example, in the case of Bluetooth or IEEE802.11 links. The limited range of the direct LAN/PAN connection significantly reduces the probability of positive correlation taking place; i.e., correlation when the profiles match.

It is, thus, an object of the present invention to provide a method which can be used by a subscriber of a communication system to identify supply and demand profiles from other subscribers of the communication system easily and quickly in a domain which is of interest in terms of space and time for making direct personal contact, and possibly to make immediate contact with one or more subscribers.

### SUMMARY OF THE INVENTION

Accordingly, the present invention provides a method for duplicating and distributing information for identifying profiles of subscribers of a communication system, in which:
a. the subscribers define and store subscriber-specific profiles using a respective input unit in a respective communication appliance and/or in a respective module coupled to a respective communication appliance;
b. the respective module coupled to a respective one of the communication appliances is used to receive profiles from other subscribers of the communication system on the basis of wireless, locally limited network technology;
c. the profiles received are compared with the profile which is defined and stored in the respective communication appliance in line with a profile-specific correlation threshold; wherein
d. activation by the subscriber on the respective communication appliance stores the received profiles in the respective communication appliance and compares them with one another in line with respective profile-specific correlation thresholds;
e. activation by the subscriber on the respective communication appliance stores the received profiles in the respective communication appliance and, in the event of a change of location of the respective communication appliance and/or as time progresses, compares them, in line with the respective profile-specific correlation thresholds, with profiles which are newly received and stored on the basis of wireless, locally limited network technology using the module coupled to the respective communication appliance due to the change of location and/or the progression of time; and
f. a respective instance of the profile-specific correlation thresholds being exceeded is communicated to the respective subscribers having the corresponding subscriber-specific profiles.

In this case, the input unit may be, by way of example, a keypad on a mobile communication appliance, such as a mobile telephone, or a keyboard on a computer unit, such as a personal computer (PC). A further option is to input the profile on an external appliance, such as on a personal computer (PC), and to transmit the data to the communication appliance via a wireless interface, generally via a radio or infrared interface.

The module coupled to a communication appliance may be integrated into the communication appliance and, thus, may be part of the communication appliance or may be connected as an external module to the communication appliance in the form of a “plug on” module.

In one preferred embodiment of the inventive method, profiles of other subscribers are stored only temporarily in a subscriber's communication appliance. When a defined period has elapsed since the respective profiles were stored, these profiles lose validity and are automatically deleted.

In one preferred embodiment, the wireless, locally limited network technology used is LAN (Local Area Network) and/or PAN (Personal Area Network) technology. In this case, Bluetooth technology is used with particular preference. The label Bluetooth was used in 1998 to present specifications by a “special interest group,” including experts from various companies, for a local data radio system. An unlicensed frequency band 2.4 GHz (ISM band) is used to provide the subscribers in the communication system with a transmission capacity of up to approximately 1 Mbit/s. The range is low at <100 m and, thus, is designed primarily for communication in the local domain. Within the context of the present invention, Bluetooth technology is particularly well suited for the reasons listed below:
1. Bluetooth technology has been standardized throughout the world, is inexpensive and represents a mass-produced product;
2. it can be easily integrated into communication appliances using a cellular mobile radio standard, such as GSM, GPRS, EDGE, and UMTS; and
3. no costs are incurred for using a radio channel.

One drawback of Bluetooth technology is the aforementioned range limitation, wherein initially only the appliances in the immediate surroundings are contacted. The present invention now achieves scattering and distribution of profiles in a larger, but still manageable, domain, such as in an urban region, by virtue of “scattered” networks being used for duplicating and distributing information. Within the context of the present invention, “scattered” networks denote systems which include mobile ad hoc PAN/LAN systems which are terminated over time and are organized on a non-network basis. These networks arise through random clustering of at least two subscribers as a result of ad hoc contact being made with a LAN/PAN system which enters a radio cell in a further LAN/PAN system. When one of these systems leaves the radio cell, the network is terminated again. In “scattered” networks, data are interchanged bidirectionally in the time during which contact exists, even if this is very short. At first, as already known, an ad hoc connection is set up using Bluetooth technology, for example. This is used to transmit a profile of a subscriber to another subscriber. In line with the prior art, the profiles of the subscribers are correlated. In line with the present invention, a profile is received and is stored by virtue of activation of the receiving subscriber, even if no positive correlation has been made. This can be limited to relevant profiles which are distinguished, by way of example, in that the resultant correlation value is just below the defined, profile-specific correlation threshold. In line with the present invention, this results in duplication of a profile. The mobility of the subscribers now results in the stored profiles being distributed and scattered in space and time; for example, in other, possibly similar social groups. Hence, the probability of positive correlation later increases. The subscriber who has stored the profile serves as a mediator. In line with the present invention, however, the subscriber needs to have a choice of mediation and communication alternatives. These alternatives have bidirectional applicability in this case. In line with the present invention, these communication alternatives may have the following appearance:
1. The subscriber does not block or activate a mediation function on the module in his/her communication appliance. Hence, no profiles are stored, or transmitted using his own module. In addition, a subscriber advantageously may stipulate that his/her own transmitted profile is not to be stored and passed on by a foreign module.
2. The subscriber activates a mediation function on the module in his/her communication appliance for relevant profiles; for example, for profiles which are close to his/her own correlation threshold. These are stored and transmitted via the subscriber's module. Advantageously, his/her own profile also will be stored and passed on only by other modules which are relevant within the context mentioned above.
3. The subscriber activates the mediation function on the module in his/her communication appliance for all received profiles without restriction. As such, all profiles are stored and transmitted via the module. His/her own transmitted profiles then are also intended to be stored and passed on by other modules without restriction.

Preferably, the subscriber choosing one of the communication alternatives 2 or 3 additionally determines the period in which the profile will be valid. Advantageously, both the desired communication alternative and the period are part of the profile which is to be transmitted. After such a profile has been transmitted to a module, the information is stored in the module. When the time of maximum validity has been reached, it is deleted from the module.

The information from a subscriber is, thus, possibly carried along by another subscriber. Information also may be distributed using a number of mediation stages.

Subscribers who wish to convey their profiles confirm, at the same time, the desire to set up a connection upon positive correlation of their profile using a mediator.

As an alternative to Bluetooth, it is possible to use IEEE 802.11b LAN technology. Further wireless technologies for “local and personal area network” applications are currently in the standardization phase.

In this case, the technology used is preferably coupled to a mobile communication appliance operating on the basis of a cellular standard (subsequently referred to as cellular communication appliance). With particular preference, this is a mobile communication appliance based on the GSM, GPRS, EDGE and/or UMTS standard.

To identify suitable supply and demand profiles, the searching subscriber uses a categorization and description rule, for example, to define an object supply, demand or interest profile, for example, and to store it in the module or communication appliance in suitable form. The standardized categorization rule is used to describe, by way of example, the type of supply or demand object or area of interest, and the standardized, object-typical description rule is used to describe the object itself. Stipulating standardized rules makes successful correlations possible. In addition, a profile-specific correlation threshold is defined in each profile.

The module used takes wireless, locally limited network technology as a basis for automatically making contact, on an ad hoc basis, with each further module which is in the same radio cell as the searching subscriber himself/herself. Hence, a direct, bidirectional connection is set up. When a further module has been identified in the subscriber's corresponding radio cell, an ad hoc connection to this module is set up and the profiles of the corresponding subscribers are subsequently transmitted to the searching subscriber, preferably in bidirectional fashion. When the data have been received, the profiles are correlated, preferably in both modules which are involved.

In one preferred embodiment of the inventive method, each module associated with a subscriber is assigned an ID number. Advantageously, the “Bluetooth device address” supported by the Bluetooth standard is automatically used as ID number, which uniquely identifies every Bluetooth module worldwide. After the systems are first turned on, for example, the modules transmit their ID numbers using the preferably cellular communication appliances to an interposed provider. The provider thus sets up a unique association between the ID number of the module and the addressing (telephone number) of the cellular communication appliance. This association is valid only until the module is replaced. When a different module is connected to the communication appliance, the provider needs to make a new association. This can be done using the aforementioned method. The ID numbers likewise are transmitted bidirectionally between two respective modules when contact is made in order to identify the corresponding modules.

In line with the present invention, an instance of profile-specific correlation thresholds being exceeded is communicated to the respective subscribers having the corresponding subscriber-specific profiles.

For the purpose of finally making personal contact with the subscribers (i.e., to set up a direct communication connection), the following criteria are now relevant within the context of the present invention:
The network technology used cannot and is not intended to presuppose a direct visual connection, which would simplify making contact.

The desire for discretion must not make it imperative for a direct personal (visual) connection to be made or detected. In addition, it must not be imperative to set up the connection at the immediate time. It also must be possible to avoid surrendering personal details for the purpose of making direct contact, such as telephone number or address.

The subscriber has full flexibility to accept or decline personal contact under full protection of his/her privacy.

If a direct communication connection is to be set up, this is done, in line with the present invention, by virtue of respective suitable activation at the subscriber end. Such activation can be performed, by way of example, by pressing a key on the module or on the input unit of the communication appliance. In line with the present invention, a communication connection, preferably a GSM, GPRS, EDGE or UMTS connection, is first automatically set up to an interposed “provider” of the communication system. This interposed provider undertakes to organize the contact which is to be made. The contact made may be organized in the manner below, for example.

A module associated with a subscriber A transmits the ID number of a module associated with a subscriber B whom subscriber A wishes to contact to the interposed provider with a contact request using the preferably cellular communication appliance. This ID number, which is stored at the provider's premises, can be used for uniquely identifying subscriber B and the associated module. The provider checks whether subscriber B's module or subscriber B, with whom subscriber A wishes to make contact, likewise has expressed an interest, within the framework of a time window which is to be defined, in making contact after the ID number likewise has been transmitted to him/her together with a contact request. If this is not the case, then direct contact is not possible. Depending on the tariff structure, subscriber A's provide also may calculate a charge in the case of unsuccessful direct contact.

If subscriber B is interested in making contact, then subscriber B or subscriber B's module transmits the ID number of A together with a contact request to the provider likewise using the preferably cellular communication appliance. If the two contact requests and the ID numbers of the modules are available in a defined time window, then it is possible to make contact. Preferably, a respective neutral telephone number is assigned to the subscribers in order to set up a communication connection between the subscribers A and B. This provides the option of both subscribers being able to use neutral telephone numbers to make contact, the telephone numbers being different than the personal telephone number in order to protect anonymity. The neutral telephone numbers are preferably assigned temporarily for a time window which is to be determined. The provider may levy a charge for each successful contact made by the subscribers A and B, for example, the charge being on the order of magnitude of an SMS (Short Message Service) transmission today, for example. Thus, contact is successfully set up. Subscribers A and B can now make arrangements verbally.

In a further application of the present invention, one of the subscribers may be a fixed or mobile provider of a product or service. In line with the description given, the supply or demand is communicated to each passing subscriber in a limited radius, such as in an urban area, using the technology described. According to known terminology, this service can be referred to as a “located based offer” or “located basedservices.” Besides information relating to an accurate local description of the location, the provider of the service may, upon confirmation of the interest by a potential customer, be sent further information, such as prices, about the communication appliance. Unlike in the case of the application above, the provider of the service advantageously confirms the correlation automatically.

One advantage of the present invention over identification systems which already exist and have been mentioned at the outset can be seen, inter alia, in that the search area of subscribers with supply and demand wishes is expanded usefully in terms of space without going beyond the everyday ranges of activity of normal subscribers. The probability of a successful search beyond the search radius known to date is, thus, increased.

A further advantage of the present invention can be seen in that replicating the supply or demand generates multipliers. The simultaneous, spatially separate search for a number of modules increases the probability of a successful search. In addition, a good distribution of information in and between groups, such as with similar areas of interest, is ensured. Furthermore, a certain educational effect can be used in that frequently receiving similar relevant profiles makes priorities or trends recognizable.

A further advantage of the present invention can be seen in that the search for a suitable profile is performed at constant locations and times without the need for the corresponding subscriber to take action repeatedly. As such, the search is performed in parallel with another business activity. In addition, as already mentioned, the search is discrete and anonymous. It can be controlled without obligation and personally.

The present invention also relates to a module which can be used for the inventive method and which can be integrated into a mobile communication appliance associated with a subscriber and/or can be coupled to a mobile communication appliance associated with a subscriber via an interface and has at least the following elements:
A. a memory unit for storing a profile of the subscriber himself/herself,
B. a transmission and reception unit, operating on the basis of wireless, locally limited network technology, for transmitting and receiving (scanning) foreign profiles from other subscribers of a communication system;
C. a memory unit for storing the foreign profiles which have been received;
D. a correlation unit for comparing profiles with one another; and
E. a signaling/synchronization unit.

The module's components described above also may become components of the communication appliance with increasing integration. Thus, by way of example, the memory units may be integrated into the communication appliance's memory, the function of the correlation unit may be performed by the communication appliance's processor and the function of the signaling and synchronization unit may be adopted by additional hardware in the communication appliance. A characteristic of the module fully integrated into the communication appliance is the LAN/PAN technology and the specific software for providing and controlling the additional functionality.

The mobile communication appliance preferably supports cellular communication standards, such as GSM, GPRS, EDGE or UMTS. The most important components of the communication appliance are the mobile radio hardware and software with an interface for the module and the input unit.

Preferably, the transmission and reception unit is a unit operating on the basis of LAN and/or PAN technology.

Also preferably, the memory units are RAM(s) specific to this function. In addition, the memory units also may be produced by memory units in the module hardware or in the hardware of the communication appliance.

The correlation unit is preferably a microcomputer or DSP (Digital Signal Processor). The function of the correlation unit also may be provided by the existing module hardware or by the hardware of the communication appliance with additional software.

In addition, the signaling/synchronization unit is preferably a software-assisted circuit. Alternatively, this may be the module hardware or may be integrated into the hardware of the communication appliance.

Additional features and advantages of the present invention are described in, and will be apparent from, the following Detailed Description of the Invention and the Figures.

### BRIEF DESCRIPTION OF THE FIGURES

FIG. 1 shows a schematic flowchart of an exemplary embodiment of the inventive method.

FIG. 2 shows a schematic illustration of an embodiment of an inventive module which is integrated in a mobile communication appliance.

### DETAILED DESCRIPTION OF THE INVENTION

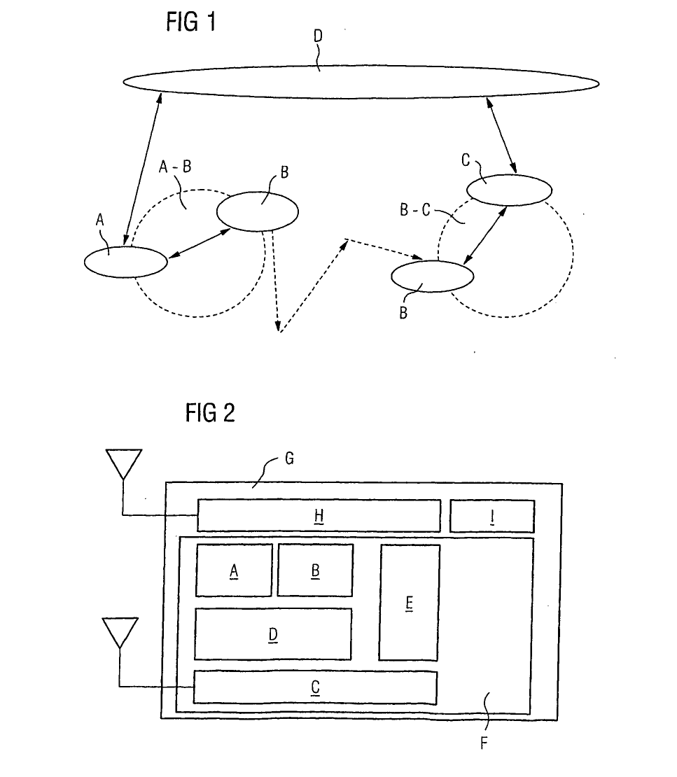

FIG. 1 shows a schematic flowchart of an exemplary embodiment of the inventive method. Subscriber A and subscriber B initially belong to a subscriber group AB. An ad hoc connection is set up between A and B; for example, using Bluetooth technology. A profile and an ID number for A are transmitted to B. Similarly, a profile and an ID number for B are transmitted to A, with subsequent correlation. In addition, the profile of A is automatically stored in B's module in the example shown. This storage also takes place in the event of negative correlation; for example, when the correlation threshold has almost been reached. This results in duplication of profile A in B's module, which increases the probability of a positive correlation later. Subscriber B, thus, serves as a mediator for subscriber A. The information from profile A is carried along by subscriber B. B's module contacts each further module which is in the radio cell. Assuming that subscriber B is acting in similar social groups, the probability of a positive correlation likewise increases. In this case, B changes from group AB to a further group BC. Following identification of a further module C in the group BC, a connection to module C is set up and, not only the profile of B and the ID number of B, but also the profile of A and the latter's ID number are transmitted to C. When the data have been received in C's module, the profiles are correlated, preferably when the profile from subscriber B starts. Upon positive correlation of the profile of subscriber B, the correlation of the profile from A advantageously may be terminated in order to prevent collisions.

An instance of a respective correlation threshold being exceeded is communicated to the corresponding subscribers. In the present case, any correlation between B and C is communicated both to B and C. If B is not correlated to C, but to A, this likewise be communicated to C. Subscriber C has the option of appropriate activation, such as pressing a key on the input unit of his/her module or of the communication appliance, in order to express the desire to set up a communication connection. Subscriber B is notified, preferably audibly or visually, that the correlation is a mediation action from A and C. A GSM connection is then automatically set up from A and C to a provider D of the communication system. If subscribers A and C use the described algorithm within a stipulated time window to express the desire for mediation, provider D assigns subscriber A a temporary telephone number for subscriber C and assigns subscriber C a temporary telephone number for subscriber A. These telephone numbers are assigned to the subscribers as appropriate, so that subscribers A and C can, respectively, make contact with one another using these telephone numbers.

FIG. 2 shows a module F which is integrated in a mobile communication appliance G. The mobile communication appliance G contains, as a component, the radio hardware H and software with an interface for the module F and the input unit I. Module F contains a memory unit A for storing its own profile, a memory unit B for storing foreign profiles, or profiles of other subscribers which are to be transmitted, a transmission and reception unit C, operating on the basis of wireless, locally limited network technology, for transmitting and receiving (scanning) the profiles of the subscribers in communication systems, a correlation unit D for comparing profiles with one another and a signaling/synchronization unit E.

Although the present invention has been described with reference to specific embodiments, those of skill in the art will recognize that changes may be made thereto without departing from the spirit and scope of the present invention as set forth in the hereafter appended claims.

1-14. (canceled)

15. A method for duplicating and distributing information for identifying profiles of subscribers of a communication system, the method comprising:
defining and storing, by the subscribers, subscriber-specific profiles using a respective input unit in a respective module coupled to a respective communication appliance;
using the respective module coupled to a respective communication appliance to receive profiles from other subscribers of the communication system based on wireless, locally limited network technology;
comparing received profiles to the profile which is defined and stored in the respective communication appliance in line with a profile-specific correlation threshold;
storing, upon activation by a subscriber, on the respective communication appliance the received profiles of the respective communication appliance;
comparing, by the respective communication appliance, the received profiles of the respective communication appliance with one another in line with respective profile-specific correlation thresholds;
storing, upon activation by the subscriber, on the respective communication appliance the received profiles of the respective communication appliance;
comparing, upon at least one of a change of location of the respective communication appliance and a progression of time, the received profiles, in line with the respective profile-specific correlation thresholds, with profiles which are newly received and stored based on wireless, locally limited network technology profiles of other subscribers of the communication system using the module coupled to the respective communication appliance due to at least one of the change of location and the progression of time; and
communicating a respective instance of the profile-specific correlation thresholds being exceeded to the respective subscribers having the corresponding subscriber-specific profiles.

16. A method for duplicating and distributing information for identifying profiles of subscribers of a communication system as claimed in claim 15, wherein profiles from other subscribers are temporarily stored in a communication appliance of a subscriber.

17. A method for duplicating and distributing information for identifying profiles of subscribers of a communication system as claimed in claim 15, wherein when profile-specific correlation thresholds are exceeded, an interposed provider of the communication system is used to set up a communication connection between the respective subscribers having the corresponding subscriber-specific profiles upon respective activation by the subscribers.

18. A method for duplicating and distributing information for identifying profiles of subscribers of a communication system as claimed in claim 15, wherein the wireless, locally limited network technology used is at least one of LAN technology and PAN technology.

19. A method for duplicating and distributing information for identifying profiles of subscribers of a communication system as claimed in claim 18, wherein the wireless, locally limited network technology used is Bluetooth.

20. A method for duplicating and distributing information for identifying profiles of subscribers of a communication system as claimed in claim 15, wherein the respective communication appliance used is a mobile communication appliance operating based on a standard, the standard being one of GSM, GPRS EDGE and UMTS.

21. A method for duplicating and distributing information for identifying profiles of subscribers of a communication system as claimed in claim 15, wherein each module associated with a subscriber is assigned an ID number.

22. A method for duplicating and distributing information for identifying profiles of subscribers of a communication system as claimed in claim 15, wherein the input unit is a computer.

23. A method for duplicating and distributing information for identifying profiles of subscribers of a communication system as claimed in claim 17, wherein a communication connection is set up between subscribers by assigning the respective subscribers a respective neutral telephone number.

24. A method for duplicating and distributing information for identifying profiles of subscribers of a communication system as claimed in claim 23, wherein the neutral telephone numbers are assigned on a temporary basis.

25. A module for integration into a mobile communication appliance which is at least one of associated with a subscriber and coupled to a mobile communication appliance associated with a subscriber via an interface, the module comprising:
a memory unit for storing a profile of the subscriber;
a transmission and reception unit operating on a basis of wireless, locally limited network technology, for transmitting and receiving foreign profiles from other subscribers of a communication system;
a memory unit for storing the foreign profiles received;
a correlation unit for comparing the profiles with one another; and
a signaling/synchronization unit for indicating respective instances of the profile-specific correlation thresholds being exceeded.

26. A module for integration into a mobile communication appliance as claimed in claim 25, wherein the transmission and reception unit operates based on at least one of LAN technology and PAN technology.

27. A module for integration into a mobile communication appliance as claimed in claim 25, wherein the memory units are RAMs.

28. A module for integration into a mobile communication appliance as claimed in claim 25, wherein the correlation unit is a microcomputer.

29. A module for integration into a mobile communication appliance as claimed in claim 25, wherein the signaling/synchronization unit is a software-assisted circuit.
